(19) United States
(12) Patent Application Publication
(10) Pub. No.: US 2024/0351431 A1
(43) Pub. Date: Oct. 24, 2024

(54) AN AIR FLOW METERING DEVICE FOR CONTROLLING THE FLOW OF AIR INTO A VEHICLE PASSAGE

(71) Applicant: Magna Exteriors Inc., Concord (CA)

(72) Inventors: Jeffrey Bruce MANHIRE, Rochester, MI (US); Sean E. GRANGER, Detroit, MI (US); Braendon R. LINDBERG, Metamora, MI (US); Jason MEYERS, Shelby Township, MI (US); Paul Nicholas WOODSON, Detroit, MI (US)

(73) Assignee: Magna Exteriors Inc., Aurora, ON (CA)

(21) Appl. No.: 18/687,525

(22) PCT Filed: Sep. 15, 2022
(86) PCT No.: PCT/US2022/043599

§ 371 Date: Feb. 28, 2024

Related U.S. Application Data
(60) Provisional application No. 63/244,543, filed on Sep. 15, 2021.
(60) Provisional application No. 63/289,469, filed on Dec. 14, 2021.

(51) Int. Cl. B60K 11/08; B60K 11/04

(52) U.S. Cl. CPC B60K 11/085; B60K 11/04; B60Y 2400/411

(57) ABSTRACT

An airflow metering device for metering airflow to a heat exchanger of a vehicle includes a first movable airflow fabric member and a second airflow fabric member. In a first closed position, the first movable airflow fabric member and second airflow fabric members meet at a central area of the airflow. The first movable airflow fabric member and second airflow fabric member are actuatable for withdrawing away from each other for providing an opening from the close position outward. This provides a central opening for metering airflow to the heat exchanger such as a radiator or the like. A continuous loop drive system is used for actuating both first and second airflow fabric members simultaneously.

### CROSS-REFERENCE TO RELATED APPLICATIONS

This application is an International Patent Application and claims benefit of U.S. Provisional Patent Application No. 63/244,543 filed Sep. 15, 2021, and U.S. Provisional Patent Application No. 63/289,469 filed Dec. 14, 2021. The disclosure of the above applications are incorporated herein by reference.

### FIELD OF THE INVENTION

The present invention relates to a center-opening panel and drive arrangements for controlling air flow through a heat exchanger or other vehicle passage.

### BACKGROUND OF THE INVENTION

Several current active grill shutter system designs implement vanes for opening and closing a path of airflow. The use of vanes causes leak paths between the vanes that contribute to lower aerodynamic counts and decrease efficiency. This results in higher emissions for internal combustion vehicles and lower driving range for electric vehicles. Fabric-panel roller shade style devices have been developed but include complicated mechanisms for controlling the panel. Also, fabric panel shades which open from the bottom do not provide optimal airflow through the cooling module when only partially opened, as the airflow is focused on the bottom of the heat exchanger.

There is a need to provide similar aerodynamic efficiency achieved by roller shade style systems that have reduced complexity.

### SUMMARY OF THE INVENTION

An airflow metering device for metering airflow through a passage in a vehicle. The air flow metering device includes an airflow path with a first roller positioned at a first side of the air flow path and a second roller positioned at an opposing side of the air flow path. A continuous roll of double panel fabric material connected between the first roller and the second roller so that the continuous roll of double panel fabric material extends across the airflow path. A first fabric covering and a second fabric covering of the continuous roller of double panel fabric material that are rotated by first roller and the second roller to meet at a middle of an air flow path to create a blockage. There is a first opening and a second opening of the continuous roller of double panel fabric material that are rotated such that the first roller and the second roller rotate the first fabric covering and the second fabric covering onto the first roller and second roller thereby aligning the first opening and the second opening to form an opening starting at the middle of the air flow path, as the first fabric covering and the second fabric covering withdraw away from each other to are rolled onto a respective one of the first roller and the second roller.

In one embodiment, a continuous loop drive system is used for actuating both first and second airflow fabric members simultaneously. This provides for improved and rapid opening of the apparatus at the center.

One embodiment of the invention is directed to an air flow metering device for controlling the flow of air into a vehicle passage. The air flow metering device includes a frame with an aperture for a vehicle providing an air flow path. There is a first roller located above the aperture and a second roller located below the aperture opposite the first roller. Extending across the aperture is a single roll having a fabric covering section and a window section, where the fabric covering section is connected to the first roller and the widow section is connected to the second roller. In order to actuate the air flow metering device there is provided an actuator rotatably connected to the first roller, wherein when the actuator is rotated in a first direction the window covering section of the single roll is rolled onto the first roller as the first roller and second roller rotate in first direction, thereby opening the aperture. Also provided is a spring connected to the second roller that biases the second roller to rotate in a second direction so that the first roller, second roller and the actuator will rotate in a second direction when the actuator is disengaged, thereby causing the fabric covering section to unwind from the first roller while the window section becomes wound onto the second roller thereby covering the aperture.

Another embodiment of the invention is directed toward an air flow metering device for controlling the flow of air into a vehicle passage. The air flow metering device includes a frame with an aperture for a vehicle providing an air flow path. A drum located above the aperture and includes a panel winding section. Further provided is at least one strap winding section that is selectively rotatable with the drum. Also there is at least one wheel located on a side of the aperture opposite the drum and a guide having a length extending across the aperture. A panel is connected at a first end to the drum and at a second end to the guide. At least one strap is connected at a first end to the at least one strap winding section, extends around the at least one wheel and connects at a second end to the guide. An actuator is connected to the drum, wherein when the actuator rotates in a first direction the drum rotates in the first direction thereby causing the panel to move to the undeployed position and roll onto the panel winding section so the aperture in the frame is open. When the actuator rotates in the first direction the at least one strap winding section rotates in the first direction to unwind the at least one strap from the strap winding section, and when the actuator rotates in a second direction the drum rotates in the second direction thereby causing the panel to move to the deployed position and unroll the panel from the winding section; so the aperture in the frame is blocked. When the actuator rotates in the second direction the at least one strap winding section rotates in the second direction to wind the at least one strap onto the strap winding section.

Another embodiment of the invention is directed to an air flow metering device for controlling the flow of air into a vehicle passage. The air flow metering device has a frame with an aperture for a vehicle providing an air flow path. There is a drum located above the aperture and includes a panel winding section. There is a left strap winding section and right strap winding section both selectively rotatable with the drum. Further included is a left side wheel located on a left side of the aperture opposite the drum and a right side wheel located a right side of the aperture opposite the drum. Also included is a guide having a length extending across the aperture parallel to the drum. There is a panel connected at a first end to the drum and at a second end to the guide. A left side strap is connected at a first end to the drum, extends around the left side wheel and connects at a second end to the guide. A right side strap is connected at a first end to the drum, extends around the right side wheel and connects at a second end to the guide.

Movement of the air flow metering device is provided by an actuator connected to the drum. When the actuator rotates in a first direction the drum rotates in a first direction thereby causing the panel to move to the undeployed position and roll onto the panel winding section so the aperture in the frame is open. When the actuator rotates in the first direction the left strap winding section and the right strap winding section both rotate in the first direction to unwind the left side strap from the left side strap winding section and the right side strap from the right side strap winding section. When the actuator rotates in a second direction the drum rotates in a second direction thereby causing the panel to move to the deployed position and unroll the panel from the panel winding section so the aperture in the frame is blocked. When the actuator rotates in the second direction the left strap winding section and the right strap winding section both rotate in a second direction to wind the left side strap onto the left side strap winding section and the right side strap onto the right side strap winding section.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic side perspective view of an air flow metering device in the closed position according to a first embodiment of the invention.

FIG. 2 is a schematic side perspective view of an air flow metering device in the open position according to a first embodiment of the invention.

FIG. 3 is a side schematic view of end rails and seals used in the air flow metering device.

FIG. 4 is a side schematic view of an end rail and the frame used in the air flow metering device.

FIG. 5 is a schematic side perspective view of an air flow metering device in the closed position with the rollers removed according to a first embodiment of the invention.

FIG. 6 is a side schematic view of a support feature with the end rails and seals used in the air flow metering device in the closed position according to an alternate embodiment.

FIG. 7 is a side schematic view of a support feature with the end rails and seals used in the air flow metering device in the open position according to an alternate embodiment.

FIG. 8 is aa exploded plan view of a single roll air flow metering device according to a second embodiment of the present invention.

FIG. 9 is a cross-sectional side elevational view of a portion of the air flow metering device of the second embodiment of the present invention.

FIG. 10 is a cross-sectional side elevational view of a portion of the air flow metering device of the second embodiment of the present invention.

FIG. 11 is a cross-sectional side elevational view of a portion of the air flow metering device of the second embodiment of the present invention.

FIG. 12 is a cross-sectional side elevational view of a portion of the air flow metering device of the second embodiment of the present invention.

FIG. 13 is a rear side perspective view of an air flow metering device according to a third embodiment of the invention.

FIG. 14 is an enlarged view of the upper drum and actuator according to the third embodiment of the invention.

FIG. 15 is an enlarged view of a lower right wheel and strap according to the third embodiment of the invention.

FIG. 16 is an enlarged view of a lower left wheel and strap according to the third embodiment of the invention.

FIG. 17 is an enlarged view of the upper drum and actuator according to the third embodiment of the invention.

FIG. 18 is an enlarged view of the upper drum and actuator according to the third embodiment of the invention.

FIG. 19 is a rear side view of an air flow metering device according to a fourth embodiment of the invention.

FIG. 20 is an enlarged view of the lower right wheel of the fourth embodiment of the invention.

FIG. 21 is a rear side view of an air flow metering device according to a fifth embodiment of the invention.

FIG. 22 is an enlarged view of an actuator connected to a left actuator connector of a left upper drum and the actuator connected to a right actuator connector of a right upper drum.

FIG. 23 is a partial cross sectional view of the left actuator connector, the left upper drum and the actuator.

FIG. 24 is a partial cross sectional view of a left lower drum or a right lower drum of the third embodiment of the invention.

FIG. 25 is an enlarged side perspective view of a spring belt tensioner block according to a sixth embodiment of the present invention.

FIG. 26 is a side perspective view of an inline belt tensioner according to a seventh embodiment of the present invention.

FIG. 27 is an enlarged cross-sectional view of a torsion spring belt tensioner according to an eighth embodiment of the present invention.

FIG. 28 is a top elevational view of the fabric material.

### DETAILED DESCRIPTION OF THE PREFERRED EMBODIMENTS

The following description of the preferred embodiments are merely exemplary in nature and is in no way intended to limit the invention, its application, or uses.

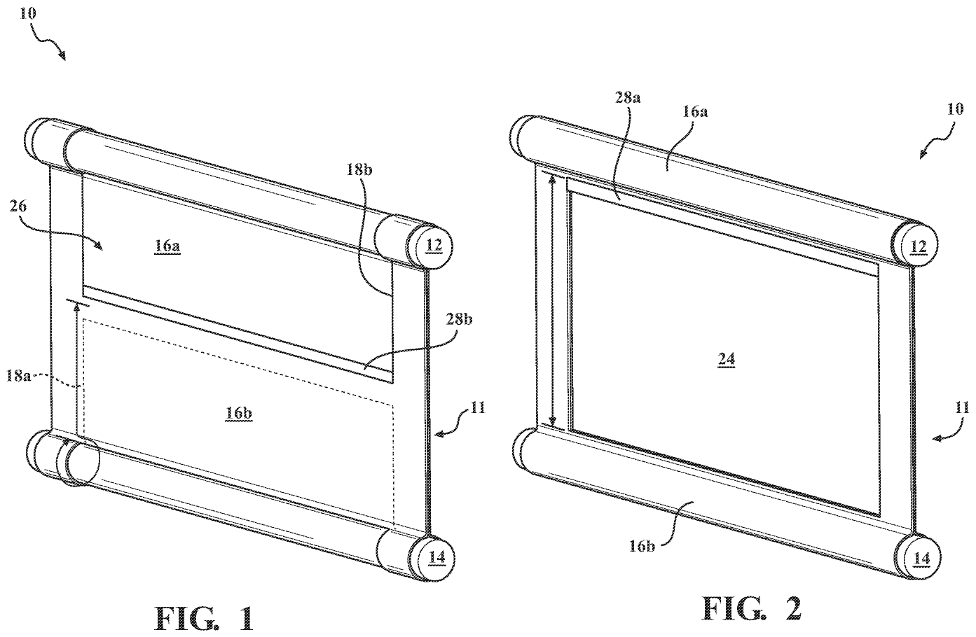

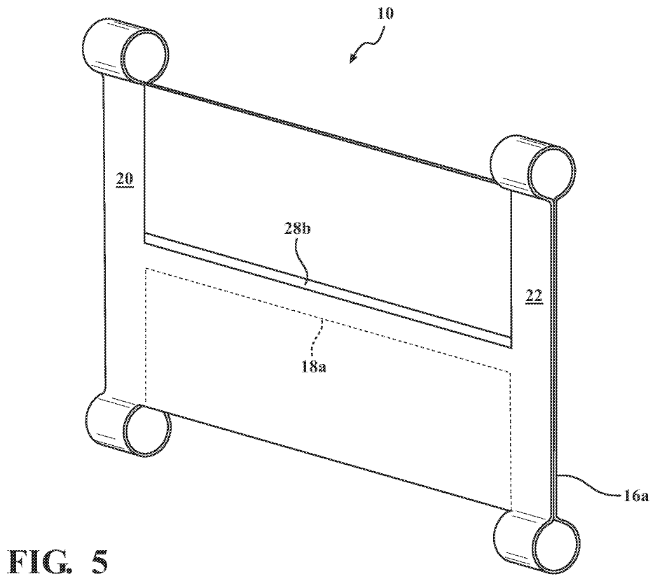

Referring now to FIGS. 1, 2 and 5 an air flow metering device 10 is shown. The airflow metering device 10 can be used to control the airflow along an airflow path. An example is the air flow path to a heat exchanger, battery pack, passenger cabin air intake or virtually another type of air flow passage on a vehicle. The air flow metering device 10 provides a continuous roll 11 of double-panel fabric that is moveable to create an airflow opening starting at the middle of the continuous roll 11 as it opens in the middle without the need to roll up the blocking material. As the material is always on the same set of rollers, it may be moved to the open condition (such as in FIG. 2 where the two openings coincide), to the closed condition (such as in FIG. 1 where the two openings are fully offset from one another), or anywhere in between these two conditions. Due to the fabric's path around the rollers, the opening size increases at twice the speed of the fabric material, so the opening or closing speed is increased.

The air flow metering device 10 has a first roller 12 and second roller 14 positioned at opposing sides of an airflow path. The first roller and the second roller are both sized to match the needs of a first fabric covering 16a and second fabric covering 16b are also referred to herein as fabric covering 16a, 16b since they are part of the same continuous roll 11 by rolling the fabric covering 16a, 16b between around the rollers 12, 14. Each fabric covering 16a, 16b has one opening 18a, 18b (18a shown in phantom), supported on the sides 20, 22, so that the fabric may be controlled as a continuous belt, which may be rotated to be in line with each other (creating an opening 24) or away from each other (creating blockage 26). To allow air to pass through the air flow metering device 10, each opening 18a, 18b in the fabric covering 16a, 16b is aligned to create and opening 24 that begins in the center of the air flow metering device and continues to get larger at the top and bottom as the fabric covering 16a, 16b continues to roll toward a respective one of the rollers 12, 14. To block air flow through the air flow metering device 10 each opening 18a, 18b are misaligned creating a blockage 26. This happens by rolling the fabric covering 16a, 16b on the rollers 12, 14 so that the fabric covering 16a, 16b blocks the opening 18a, 18b.

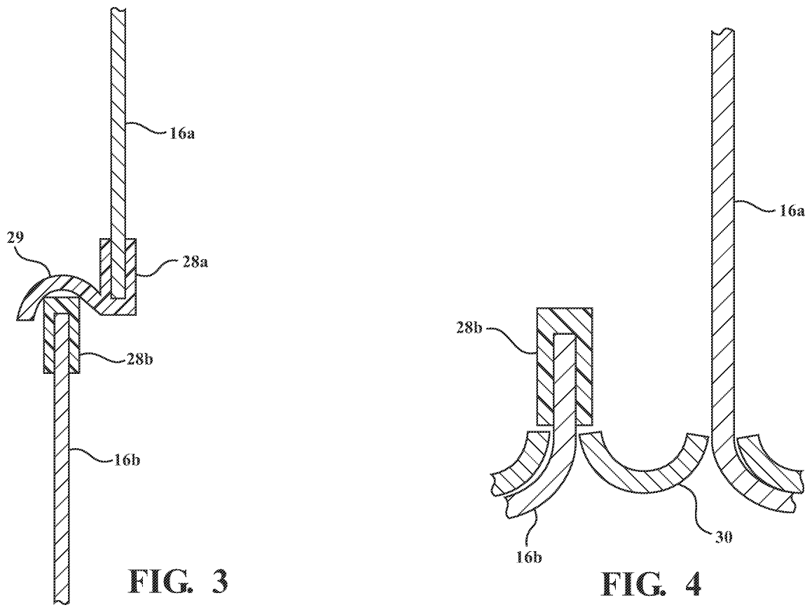

Referring now to FIGS. 3 and 4 an end rail 28a, 28b is added to a respective one of the edges of each opening 18a, 18b. Each end rail 28a, 28b is formed of a hard material such as plastic or rubber formed by co-extrusion with the same base material of the fabric covering 16a, 16b, to allow them to be fused together. Each end rail 28a, 28b functions to lock out air leakage when in the fully closed position and provide a hard surface that pushes against and seals against a frame 30 when in the fully open condition. There is also an optional seal 29 that is formed on end rail 28a, for sealing against end rail 28b. It is within the scope of the invention for the seal 29 to be formed on end rail 28b instead of or in addition to being formed on end rail 28a.

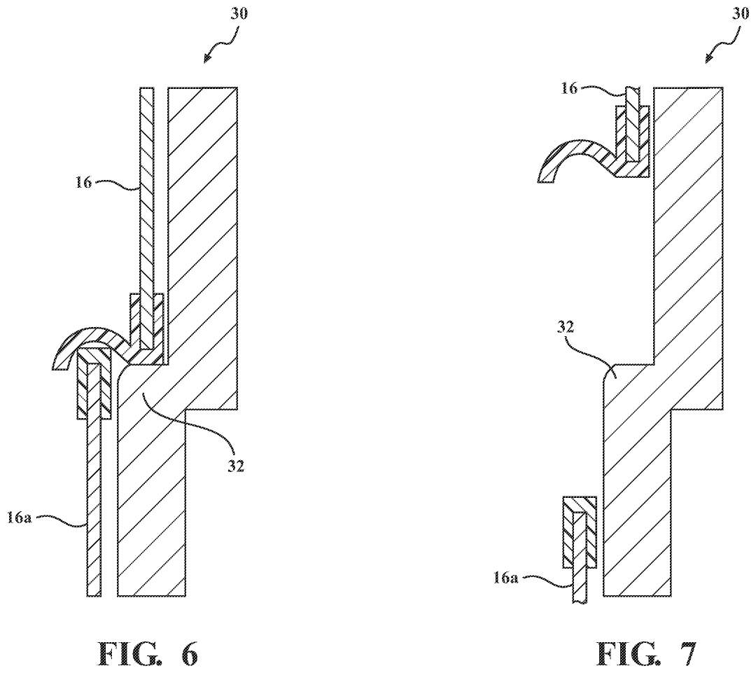

Referring now to FIGS. 6 and 7 a support feature 32 of the frame 30 is shown. The support feature 32 is a stepped portion formed on the frame 30 that provides a hard surface that supports the fabric covering 16a, 16b when moved to blockage 26 position. The support feature can be a rib that extends across the middle of the air clow metering device 10 where the opening 24 is located so as to support each end rail 28a, 28b as it moves to the blockage 26 position. Additionally, the support feature can also be located at the sides of the frame adjacent the sides 20,22 of the opening 18a, 18b and fabric covering 16a, 16b. The support feature 30 can be a single feature or multiple features depending on the needs of a particular application. The support feature 32 helps limit wear on the fabric covering 16a, 16b and side 20, 22 while moving to distribute the force of air pressure on the fabric covering 16a, 16b while the vehicle is moving.

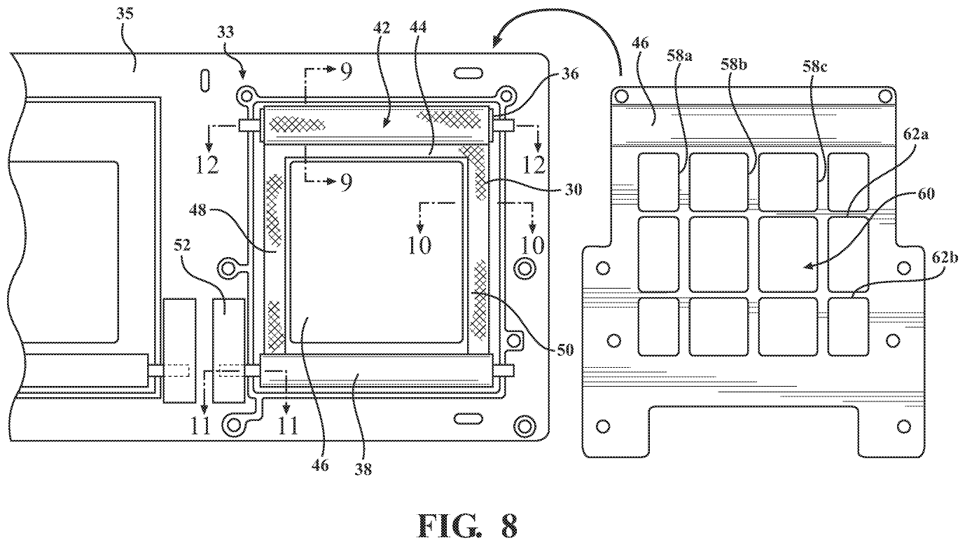

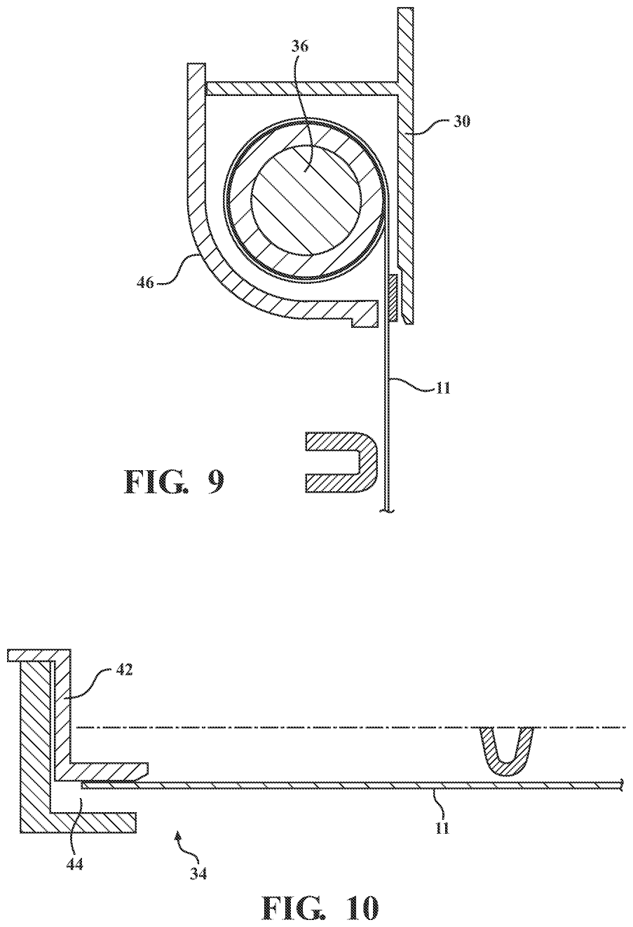

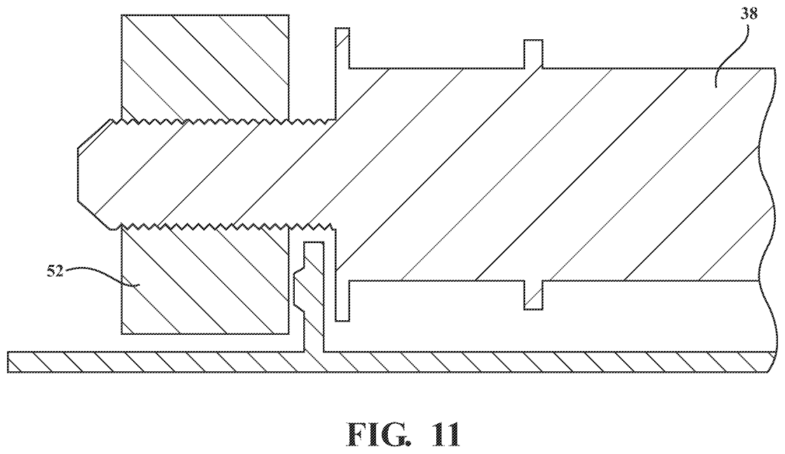

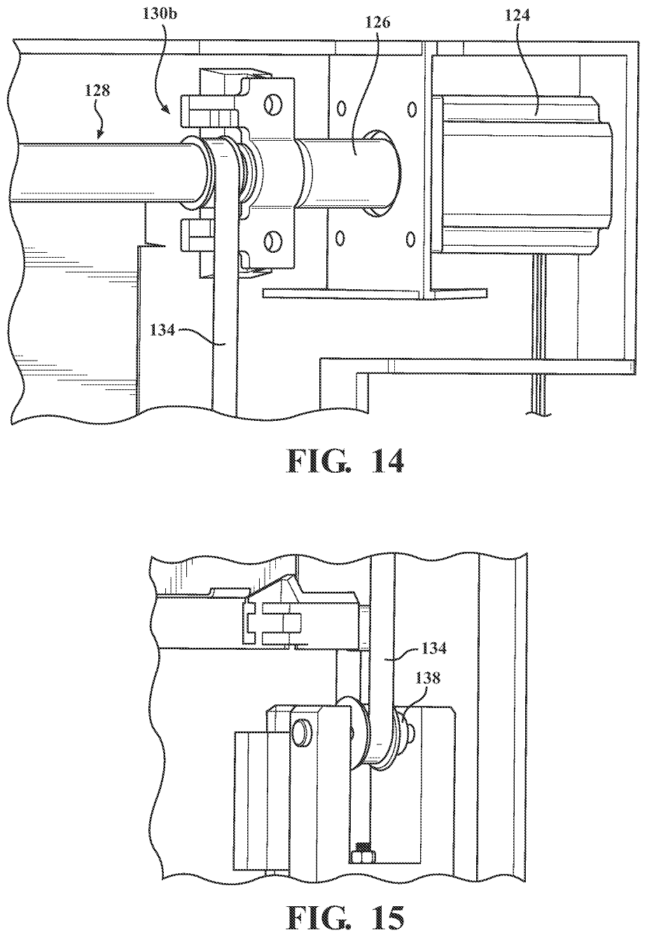

Referring to FIGS. 8-15, an air flow metering device 33, show in FIG. 8, in accordance with a second embodiment of the invention is shown being connected to a frame 35 which has an opening 34, shown in FIG. 11, that defines an air flow path. The frame 35 in this particular embodiment is part of a grille arrangement for controlling the flow of air to a heat exchanger. A first roller 36 and the second roller 38 are located on opposite sides of the opening 34. The air flow through the air flow metering device 33 is into the page shown in FIG. 8. The air flow metering device 33 in this embodiment includes a single roll 42 of fabric material that has a fabric covering section 44 and a window section 46 that has two border edges 48, 50 that roll onto the second roller 38. As currently shown in FIG. 8 the air flow metering deice is in an opening position so that the window section 46 of the single roll 42 is positioned in the opening 34 to allow air to flow through in the direction from out of the page toward the viewer as shown in FIG. 8. During operation of the air flow metering device 33 an actuator 52 acts as a one way drive to rotate the second roller 38 and the window section 46, with the border edges 48, 50 onto the second roller 38, thereby unrolling the fabric covering section 44 of the single roll 42 from the first roller 36 to block the opening 34 starting from the top and moving downward. The first roller is biased by a spring 54, which upon deactivation of the actuator 52 causes the fabric covering section 44 to be wound onto the first roller 36, while the window section 46 unwinds from the second roller 38.

Behind the single roll 42 shown in FIG. 8 is a support grid 56, shown exploded away from the frame 35. The support grid 56 connects to the frame 35 over the air flow metering device 33 and is shown connected in the cross section views shown in FIGS. 10, 11 and 12. The support grid 56 has three vertical walls 58a, 58b, 58c that extend across an opening 60 and intersect two horizontal walls 62a, 62b to create twelve sections of the opening 60 that allow air from the opening 34 in the frame to flow past the support grid 56. The support grid 56 with the vertical walls 58a, 58b, 58c and horizontal walls 62a, 62b, function to support the fabric covering section 44 of the single roll 42 to prevent buckling, jamming or breaking of the fabric covering section 44. While twelve section in the support grid 56 are shown it is within the scope of this invention for there to be a greater or lesser number of sections, or different sized section to be present depending on the needs of a particular application. Also, the support grid 56 can be used in with the continuous roll of the air flow metering device 10 shown in the first embodiment of the invention.

The support grid 56 further includes a Z shaped edge 64, shown in FIG. 11, that forms a channel 66 with the frame 35 that the single roll 42 moves within. The support grid 56 also includes a roller guard 68 that contacts the frame 35 and covers the first roller 36 to protect it from dirt and debris. The roller guard 68 has an opening 70 formed between the roller guard 68 that allows the single roll 42 to roll onto the first roller 36.

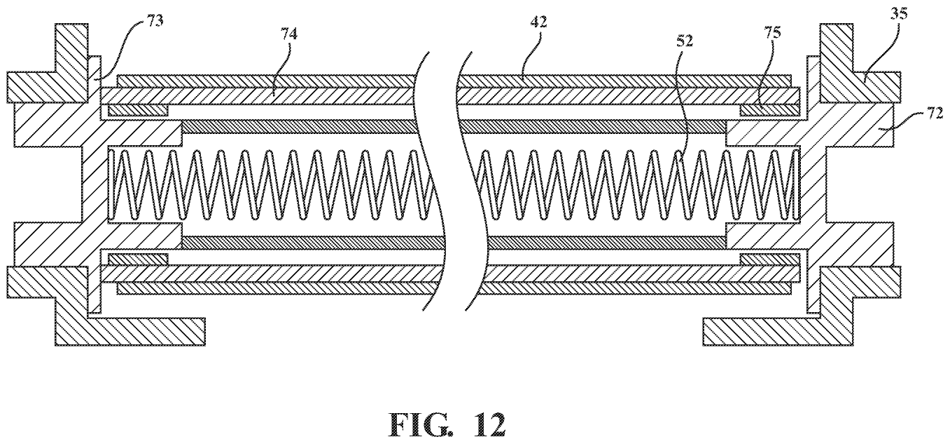

Referring now to FIGS. 12 the details of the first roller 36 are now discussed. The first roller 36 includes a fixed end cap 72 that is fixed to the frame 35 and a free end cap 73 that rotates in the frame 35. Between the fixed end cap 72 and the free end cap 73 is a tube 74 that is fixed and rotates with the fee end cap 73 and is rotatably supported on the fixed end cap 72 by a bushing 75. The single roll 42 rolls onto the tube 74. The spring 54 is positioned between and fixed to both the fixed end cap 72 and the free end cap 73 so that when the free end cap 73 rotates when the single roll 42 is rolled off the tube 74, the spring 54 will rotate and tension of the spring 54 will increase so that when the actuator 52 is deenergized the spring 54 will cause the free end cap 73 and tube 74 to rotate in the other direction and wind the single roll 42 onto the rube 74.

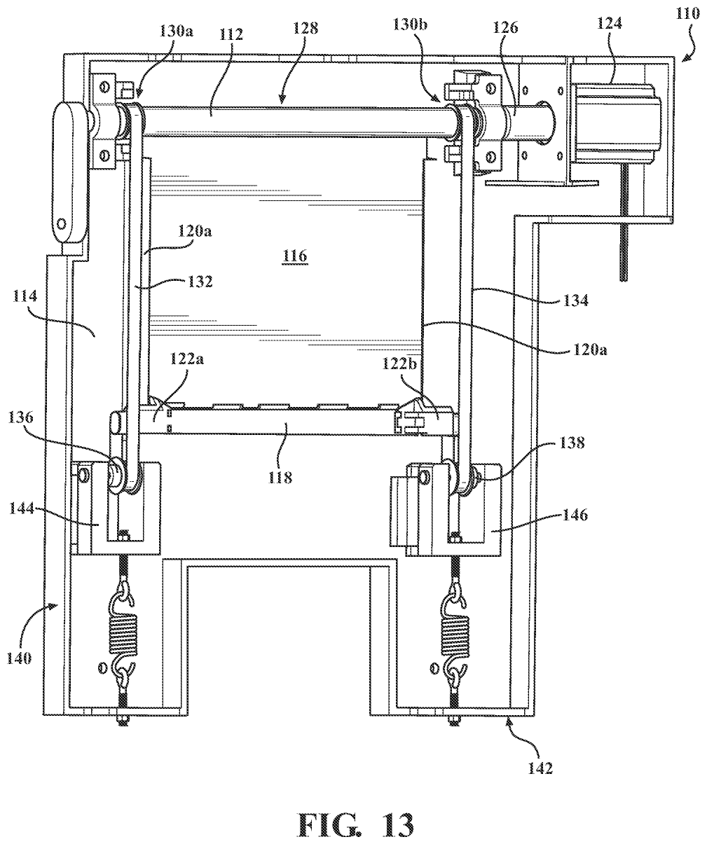

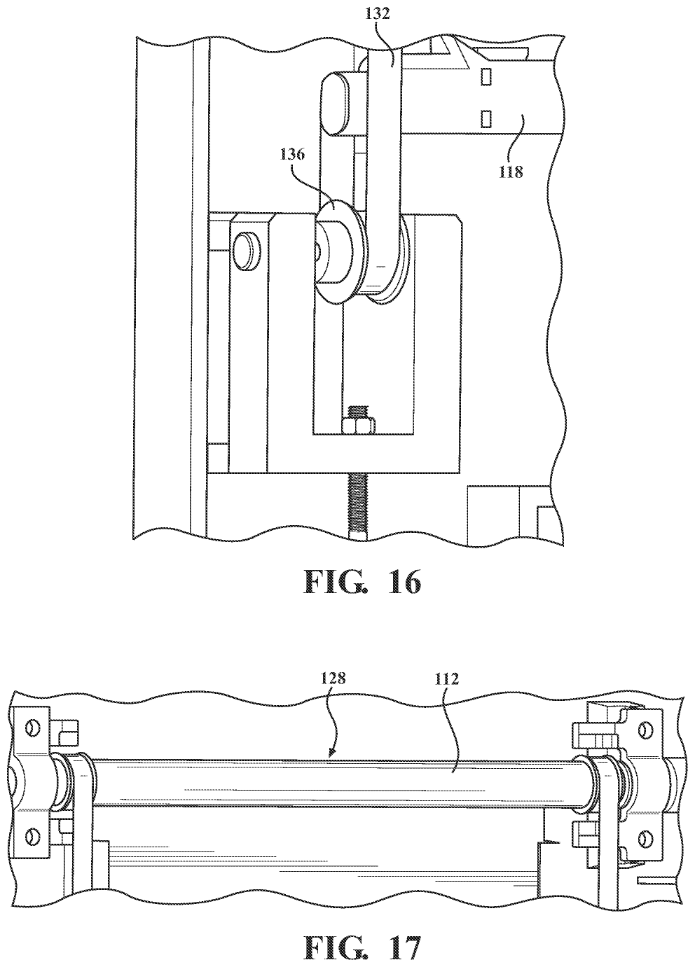

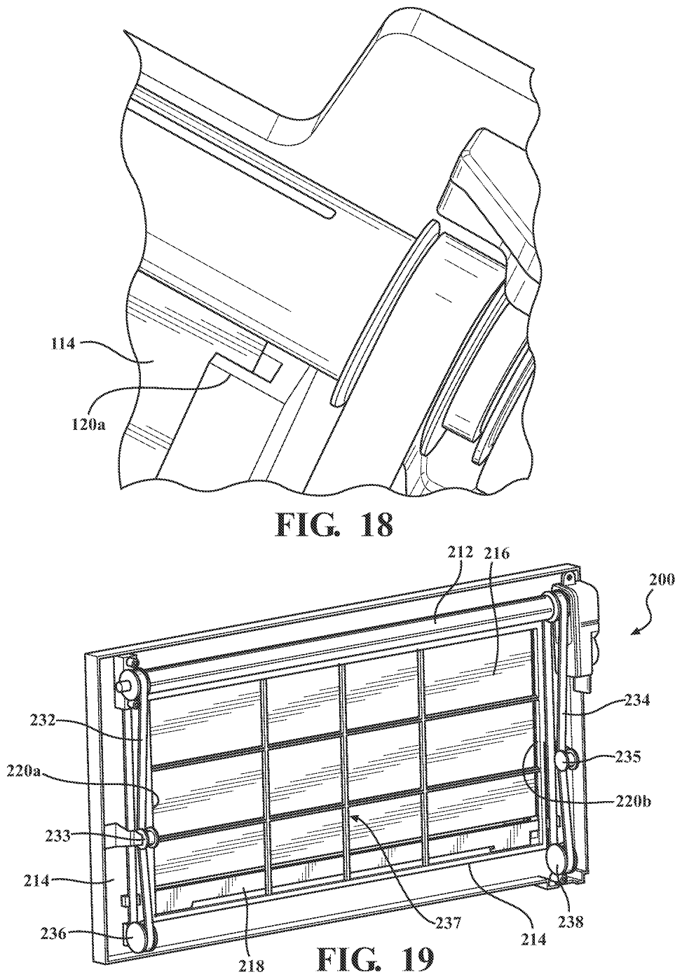

Referring now the FIGS. 13-18 an air flow metering device 100 according to another embodiment of the invention is shown. The air flow metering device 100 is used for controlling the flow of air into a vehicle, particularly air flow through the heat exchanger of the vehicle. The vehicle has an air inlet defining an air flow path. The air inlet and air flow path can be for many different types of applications, which include but are not limited to, combustion engine air intake, active aerodynamics passages, vehicle battery or electric motor cooling passages and vehicle cabin air inlet passages.

The air flow metering device 100 includes a drum 112 rotatably positioned above the air inlet formed in a frame 114. A panel 116 has a first end that is connected to and capable of being wound upon the drum 112. The panel 116 is any type of flexible sheet like material capable of being wound onto the drum 112. It is within the scope of this invention for the flexible sheet like material to have some holes for air flow or none at all. The flexible sheet like material can be made of various polymers, elastomers, woven or non-woven materials. Optionally the panel 116 further includes flexible supports or battens that function to maintain stiffness but are capable of being wound on the drum 112.

A second end of the panel 116 is connected to a guide 18 that has teeth that firmly grasp the second end of the panel 116. Frame 114 has a left side rail 20a and right side rail 20b that extend along opposing borders of the aperture of the frame 14. The guide 118 includes a left rail connection 122a and right rail connection 122b that engage and slide along the respective left side rail 120a and right side rail 120b.

During operation of the air flow metering device 100 the panel 116 is moved from a deployed position where the panel covers the aperture of the frame 114 and a retracted position where the panel 116 is rolled onto the drum 112 as shown in the drawings. The movement of the panel 116 is driven by an actuator 124. In the present embodiment the actuator 124 is a bi-directional motor having a transmission shaft 126 connected to the drum 112 that is capable of rotating the drum 112 in the clockwise or counterclockwise direction. The drum 112 includes a panel winding section 128 where the panel is wound on the drum 112. Adjacent the panel winding section 128 is a left strap 132 winding section 130a with a strap 132 having a first end connected thereto. The drum further includes a right strap winding section 130b with a strap 134 having a first end connected thereto.

The left strap winding section 310a and right strap winding section 130b each have a diameter that is larger than the strap winding section 128. The reason for the difference in diameter is to account for the differences in thicknesses between the panel 116 and the straps 132, 134. Different diameters can be used, depending on the thickness of the straps 132, 134 and the panel 116.

As shown in the figures each strap 132, 134 extends downward and wraps around a respective left side wheel 136 or right side wheel 138 that is connected to the frame 114. Each strap 132, 134 has a second end that is connected to the guide 118 above the left side wheel 136 or right side wheel 138. The left side wheel 136 has a left side tensioning element 140 and the right side wheel 138 has a right side tensioning element 142. The left side tensioning element 140 has a spring connected between the frame 114 and a left side block 144 that the left side wheel 136 is mounted on. The spring pulls on the left side block 144 to maintain tension of the strap 132. The right side tensioning element 142 is shown as a spring connected between the frame 114 and a right side block 146. The spring pulls on the right side block 146 that the right side wheel 138 is mounted on to maintain tension on the strap 134.

During operation, the panel 116 is moved between a deployed position, where the panel 116 covers the aperture in the frame 114, and an undeployed position where the panel 116 is moved to an undeployed position, where the panel 116 is rolled onto the panel winding portion 128 of the drum 112. Likewise, the straps 132, 134 wind unto the respective left side wheel 136 and right side wheel 138 when the panel 116 is in the deployed position. When the actuator 114 rotates in a first direction the drum 112 rotates in the first direction (same direction as the actuator 114) thereby causing the panel 116 to move to the undeployed position and roll onto the panel winding section 128 so the aperture in the frame 114 is open. When the actuator 114 rotates in the first direction the left strap winding section 130a and the right strap winding section 130b both rotate in the first direction (same direction as the drum 112) to unwind the left side strap 132 from the left side strap winding section 130a and the right side strap 134 from the right side strap 130b winding section. When the actuator 114 rotates in a second direction the drum 112 rotates in the second direction thereby causing the panel 116 to move to the deployed position and unroll the panel 116 from the panel winding section 128 so the aperture of the frame 114 is blocked. When the actuator 114 rotates in the second direction the left strap winding section 130a and the right strap winding section 130b both rotate in the second direction to wind the left side strap 132 onto the left side strap winding section 130a and the right side strap 134 onto the right side strap winding section 130b. The first direction and second direction as described above with one of a clockwise direction or counterclockwise direction.

Movement of the panel 116 between the deployed position and the undeployed position is caused by activation of the actuator 124 and rotation of the transmission shaft 126. As shown in the figures when the actuator 124 rotates the drum 112 in the clockwise direction the panel winding section 128 of the drum 112 begins winding the panel 116 onto the fabric winding section 128. The tension of the panel 116 as it is being wound onto the drum 112 pulls the guide 118 upward, which also pulls the straps 132, 134 as they unwind from the respective left strap winding section 130a and the right strap winding section 130b. when it is desired to move the panel 116 to the deployed position the actuator 124 rotates the transmission shaft 126 in a counterclockwise direction which causes straps 132, 134 two begin winding on the respective left strap winding section 138 and right strap winding section 130b. The tension of the straps 132, 134 pull the guide 118 downward, which pulls on the panel 116 and unwinds it from the panel winding section 128. While the operation of the air flow metering device 100 is described such that the rotation of the actuator in the clockwise or counterclockwise direction causes specific movement of the panel and the straps, it is within the scope of this invention for the components to be a ranged and a manner such that and opposite effect (i.e., rotation of the drum 112 in the counter clockwise direction causes the panel to move to the undeployed position and rotation of the drum in the counter clockwise manner, causes the panel to move to the deployed position) can be achieved.

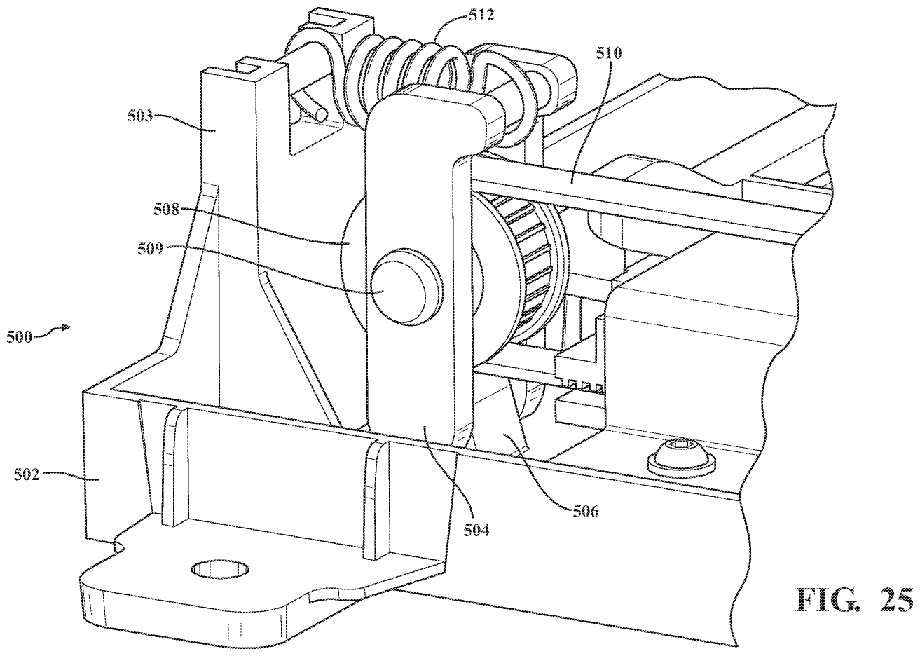

As the straps, the straps 132, 314 unwind from the respective left strapped winding section 130a and right strap winding section 130b, the panel rolls onto the drum 112 and there is a larger diameter of material of the panel 116 on the drum. Simultaneously the amount of material of the straps 132, 134 on the drum becomes smaller. This creates a problem because the straps 132, 134 can become slackened due to the differences in diameter. Different solutions for addressing the slack are discussed below with respect to FIGS. 25-27.

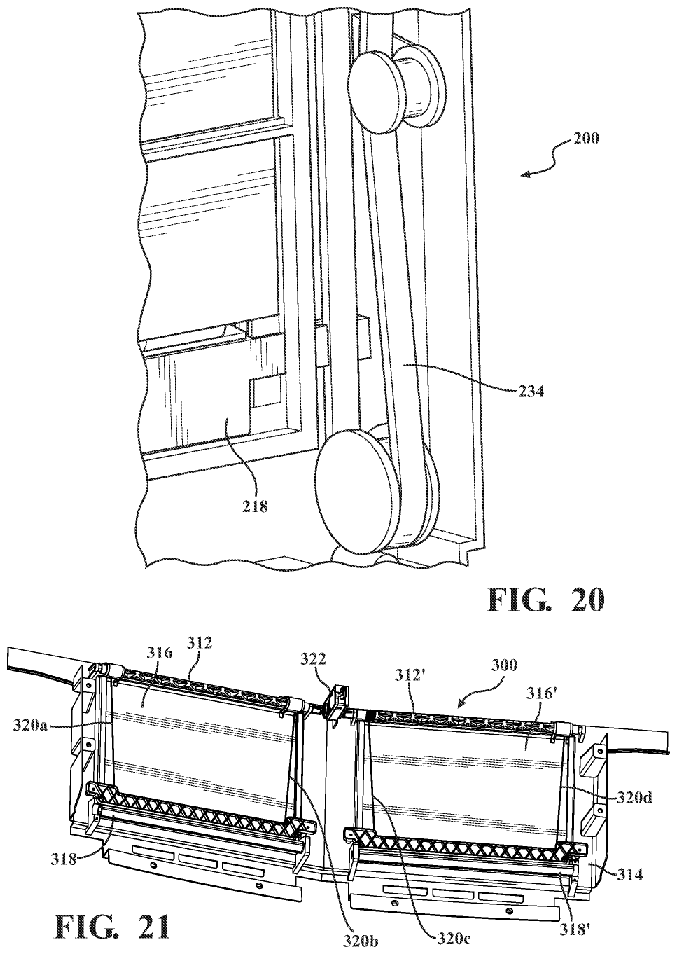

Referring now to FIGS. 19 and 20 an air flow metering device 200 according to another embodiment of the invention is shown. In this embodiment of the invention there is a panel 216 that has a first end that winds onto a drum 212 located above an aperture formed a frame 214. A second end of the panel 216 is connected to a guide 218 that extends into and moves along a left side track 220a and right side track 220b. The guide 218 is connected to a left side belt 232 and right side belt 234, which are connected between the drum 212 and respective left wheel 236 and right wheel 238. The present invention differs from the air flow metering device 100 in that it uses continuous belts forming a look or circle, rather than straps. In order to maintain tension a left tension wheel 233 is in contact with the left side belt 232 and a right tension wheel 235 is in contact with the right side belt 234 to prevent slack in the belts during operation. Also, shown in the drawing is a lattice structure 237 that helps to support the flexible panel 216 in the frame 214 and prevents the panel 216 from blowing out of the frame 214. The lattice is optional and can be used in all embodiments of the invention.

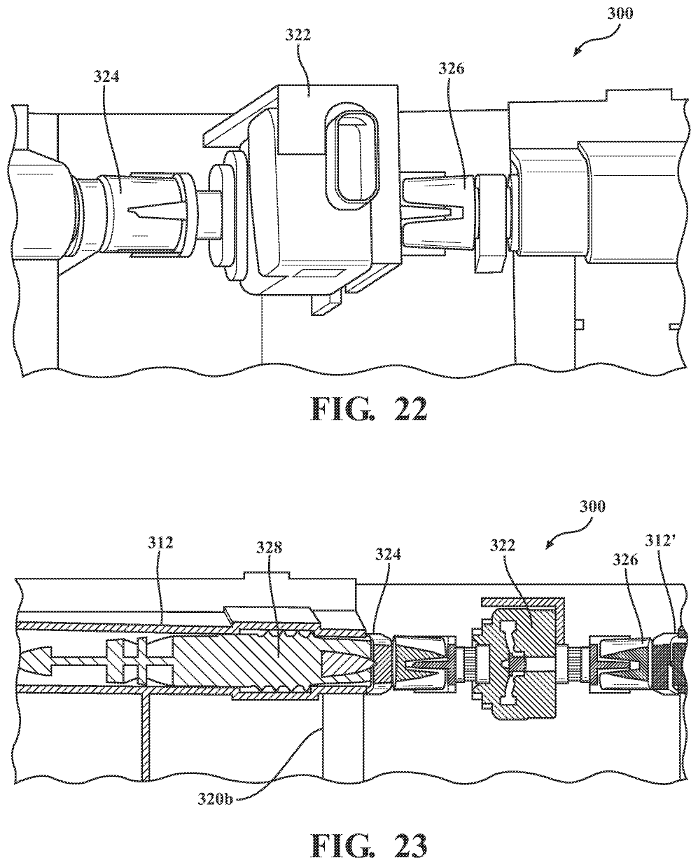

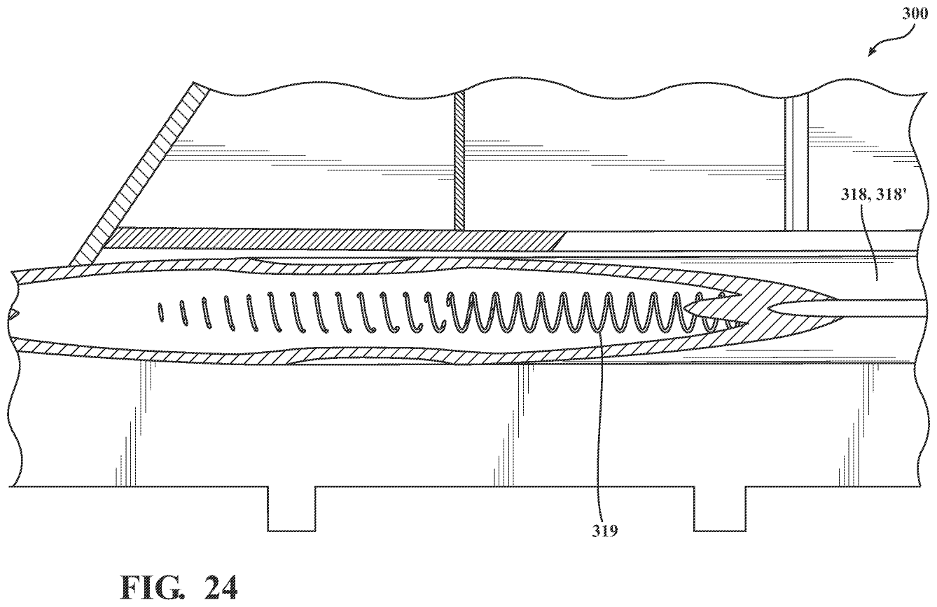

Referring now to FIGS. 21-24 an air flow metering device 300 according to a second embodiment of the invention is shown. In this embodiment of the invention there are two panels 316, 316′ that each have a first end that winds onto a drum 312, 312′ located in one of two apertures formed in a frame 314. While two apertures are shown it is within the scope of this invention to have a greater or lesser number of apertures. Also, in all other embodiments of the invention it is within the scope of the invention to have two apertures or more formed within the frame, depending on the needs of a particular application. A second end of each panel 316, 316′ is connected to a respective lower drum 318, 318′. As shown in FIG. 24 a partial cross sectional view of lower drum 318, 318′ is shown and reveals that lower drum 318, 318′ has an internal spring 319 that tensions the drum 318, 318′ toward a winding direction. Each panel 316, 316′ has a cable 320a, 320b, 320c, 320d extending along the left side and right side of the apertures. The left and right sides of each panel 316, 316′ are connected to the cable to provide transverse tension on the panel 316, 316′ and to facilitate the movement of the panel between the deployed and undeployed position. As shown in the drawings, with particular reference to FIGS. 22-23, there is a single actuator 322 that connects to a transmission shaft 324, 326 left and right side respectively, that extend into one of the two drums 312, 312′. The transmission shaft 324, 326 are identical with the exception being that one is used on the left side of the air flow metering device 300, while the other is used on the right side of the air flow metering device 300.

FIG. 23 shows the details of a tapered cable winding cone 328 connected to one end of drum 312, that winds the cable 320b as the transmission shaft 324 rotates the drum 312. There is another winding cone at the opposite end of drum 312 for winding cable 320a. Also drum 312 includes two identical winding cones for winding and unwinding a respective cable 320c, 320d. When the panel 316, 316′ is moved to the undeployed position the actuator rotates allowing the lower drum 318, 318′ to roll the respective panel 316, 316′ onto the lower drum 318, 318′. The actuator 322 rotates the upper drum 312, 312′ to wind the respective winding cone and pull the panel 316, 316′ to the undeployed position against the tension of the spring 319 in the lower drum 318, 318′. As shown a single actuator rotates two panels 316, 316′.

In all of the embodiment described above that utilize belts or straps to move the panels, it is necessary to maintain tension on the belts or straps in order to provide smooth and controlled movement of the panels between the deployed and undeployed positions. FIGS. 25-27 will now be referred to and show different tensioning mechanisms that can be utilized in any of the above embodiments that use belts or straps.

FIG. 25 in particular shows a liner spring tensioner arrangement 500 where a frame 502 of the air flow metering device has a stop surface 503 used to connect one end of a linear spring 512. Adjacent the stop surface 503 is a block 504 that is pivotally connected at a pivot 506 to the frame 502. The block 504 is able to pivot about the pivot 506. The spring 512 connects at a second end to the block 504 such that the spring 512 extends between the stop 503 and the block 504. A wheel 508 is rotatably mounted to the block 504 using a shaft 509 that allows the wheel 508 to rotate freely. A strap or belt 510 is wound about the wheel 508. Tension on the strap or belt 510 causes the block 504 to be biased to move about the pivot 506 toward the right as shown in FIG. 25, while the linear spring 512 biases the block 504 to pivot toward the left as shown in FIG. 25. These two opposing bias forces help to maintain tension on the strap or belt 510 as it moves about the wheel 508 during movement of the panel.

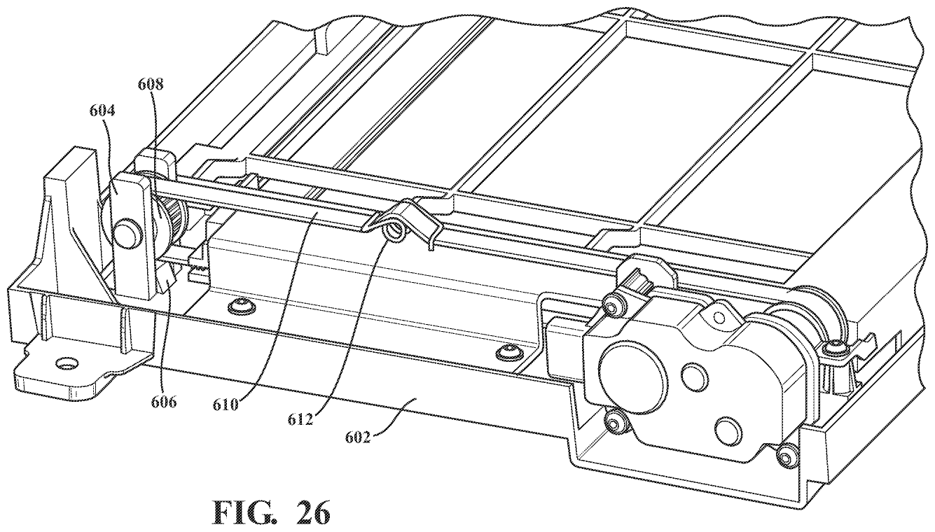

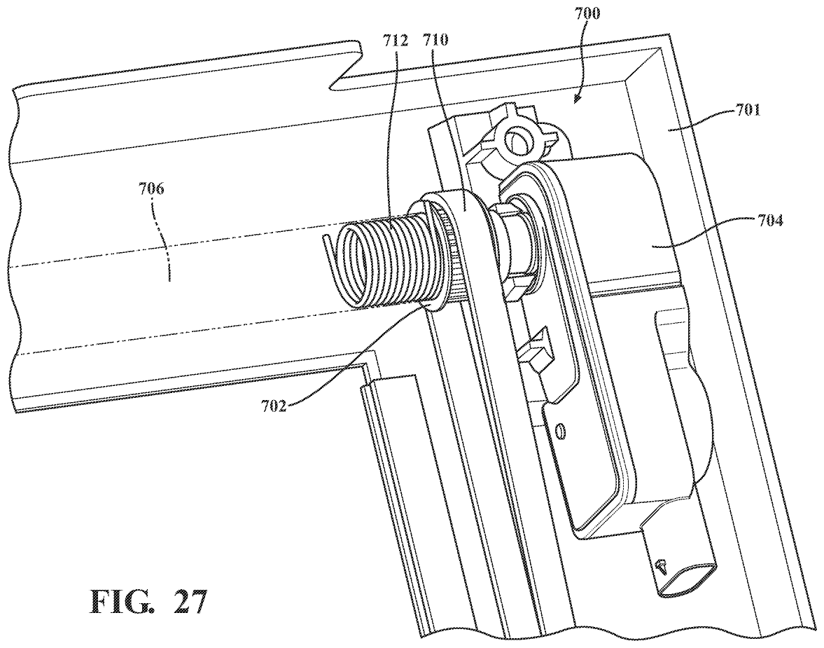

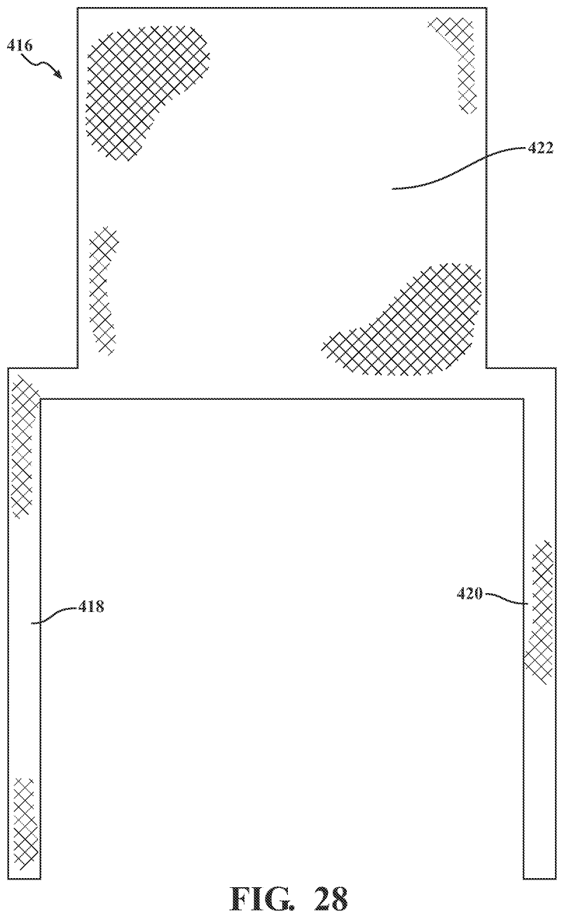

FIG. 26 shows an inline torsion spring tensioner arrangement 600 having a strap or belt 610 wound about a wheel 608 that is rotatably connected to a block 604 that is connected to a frame 602 at a pivot 606. Tension on the strap or belt 610 is maintained by using an inline spring 612 that connects in line to the strap or belt 610 in order to maintain tension.

FIG. 27 shows a drum torsion spring tensioner arrangement 700 including a frame 701 with an actuator 704 connected to the frame 701. The actuator 704 rotates a drive sprocket 702 that has a strap or belt 710 wrapped around the drive sprocket 702 for moving a fabric panel (not shown) that is windable on a fabric drum 706. The fabric drum 706 is able to rotate relative to the drive sprocket 702. Between the drive sprocket 702 and the fabric drum 706 is a drum torsion spring 712 that maintains tension between the fabric drum 706 and drive sprocket 702, thereby keeping the strap or belt 710 tensioned during movement of the fabric panel between the deployed and undeployed positions.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An air flow metering device for controlling the flow of air into a vehicle passage comprising:
a frame with an aperture for a vehicle providing an air flow path;
a first roller located above the aperture;
a second roller located below the aperture opposite the first roller;
a single roll having a fabric covering section and a window section, wherein the fabric covering section is connected to the first roller and the widow section is connected to the second roller;
an actuator rotatably connected to the first roller, wherein when the actuator is rotated in a first direction the window covering section of the single roll is rolled onto the first roller as the first roller and second roller rotate in first direction, thereby opening the aperture;
a spring connected to the second roller that biases the second roller to rotate in a second direction so that the first roller, second roller and the actuator will rotate in a second direction when the actuator is disengaged, thereby causing the fabric covering section to unwind from the first roller while the window section becomes wound onto the second roller thereby covering the aperture.

2. The air flow metering device of claim 1 further comprising border edges of the window section of the single roller, wherein the border edges are connected to the second roller.

3. The air flow metering device of claim 1 further comprising a support grid having at least one vertical wall and at least one horizontal wall, wherein the support grid is connected to the frame and extends over the single roll when connected to the frame.

4. The air flow metering device of claim 3, wherein the support grid has a roller guard that extends over the first roller and covers the fabric covering section of the single roll when the fabric covering section is rolled onto the first roller.

5. The air flow metering device of claim 1 wherein the second roller further comprises:
a fixed end cap connected to the frame so there is no rotation relative to the frame;
a free end cap rotatably connected to the frame;
a tube connected extending between the fixed end cap and the free end cap, wherein the tube is fixed to and rotates with the free end cap and rotates about a portion of the fixed end cap;
wherein the spring extends through a hollow portion of the tube and is fixedly connected at one end to the fixed end cap and a second end of the spring connects and rotates with the free end cap.

6. An air flow metering device for controlling the flow of air into a vehicle passage comprising:
a frame with an aperture for a vehicle providing an air flow path;
a drum located above the aperture, the drum including a panel winding section;
at least one strap winding section selectively rotatable with the drum;
at least one wheel located on a side of the aperture opposite the drum;
a guide having a length extending across the aperture;
a panel connected at a first end to the drum and at a second end to the guide;
at least one strap connected at a first end to the at least one strap winding section, extending around the at least one wheel and connecting at a second end to the guide, and
an actuator connected to the drum, wherein when the actuator rotates in a first direction the drum rotates in the first direction thereby causing the panel to move to the undeployed position and roll onto the panel winding section so the aperture in the frame is open, wherein when the actuator rotates in the first direction the at least one strap winding section rotates in the first direction to unwind the at least one strap from the strap winding section, and when the actuator rotates in a second direction the drum rotates in the second direction thereby causing the panel to move to the deployed position and unroll the panel from the winding section so the aperture in the frame is blocked, wherein when the actuator rotates in the second direction the at least one strap winding section rotates in the second direction to wind the at least one strap onto the strap winding section.

7. The air flow metering device of claim 6 further comprising an inline spring connected to the at least one strap for maintaining tension on the at least one strap.

8. The air flow metering device of claim 6 further comprising:
wherein the at least one wheel is connected to a block that is pivotally connected to the frame, and
a spring is connected between the frame and the block to pull the at least one wheel toward the frame to maintain tension on the at least one strap.

9. The air flow metering device of claim 6 further comprising:
a left side rail extending along the left side of the aperture in the frame, and
a right side rail extending along the right side of the aperture in the frame, wherein a portion of the panel extends into the left side rail and the right side rail.

10. The air flow metering device of claim 6 further comprising:
wherein the at least one strap winding section includes a drive sprocket connected between the actuator and the drum, wherein the drum freely rotates relative to the drive sprocket, and
a drum torsion spring located between the drive sprocket and the drum, wherein the drum torsion spring maintains tension between the drum and the drive sprocket when the actuator is rotating in the first direction or the second direction.

11. The air flow metering device of claim 6 wherein the at least one strap is at least one cable and the at least one strap winding section is a tapered cable winding cone connected to the drum for winding and unwinding the at least one cable.

12. An air flow metering device for controlling the flow of air into a vehicle passage comprising:
a frame with an aperture for a vehicle providing an air flow path;
a drum located above the aperture, the drum including a panel winding section;
a left strap winding section selectively rotatable with the drum and a right strap winding section selectively rotatable with the drum;
a left side wheel located on a left side of the aperture opposite the drum and a right side wheel located a right side of the aperture opposite the drum;
a guide having a length extending across the aperture parallel to the drum;
a panel connected at a first end to the drum and at a second end to the guide;
a left side strap connected at a first end to the drum, extending around the left side wheel and connecting at a second end to the guide;
a right side strap connected at a first end to the drum, extending around the right side wheel and connecting at a second end to the guide; and
an actuator connected to the drum, wherein when the actuator rotates in a first direction the drum rotates in a first direction thereby causing the panel to move to the undeployed position and roll onto the panel winding section so the aperture in the frame is open, wherein when the actuator rotates in the first direction the left strap winding section and the right strap winding section both rotate in the first direction to unwind the left side strap from the left side strap winding section and the right side strap from the right side strap winding section, and when the actuator rotates in a second direction the drum rotates in a second direction thereby causing the panel to move to the deployed position and unroll the panel from the panel winding section so the aperture in the frame is blocked, wherein when the actuator rotates in the second direction the left strap winding section and the right strap winding section both rotate in a second direction to wind the left side strap onto the left side strap winding section and the right side strap onto the right side strap winding section.

13. The air flow metering device of claim 12 further comprising an inline spring connected to the left side strap and an inline spring connected to the right side strap for maintaining tension on the left side strap and the right side strap.

14. The air flow metering device of claim 12 further comprising:
wherein the lift side wheel is connected to a block that is pivotally connected to the frame and the right side wheel is connected to a block that is pivotally connected the frame, and
a first tension spring connected between the frame and the block that the left side wheel is connected to and a second tension spring connected between the frame and the block that the right side wheel is connected to, wherein the first tension spring and the second tension spring pull the respective left side wheel and the right side wheel toward the frame to maintain tension on the left side strap and the right side strap.

15. The air flow metering device of claim 12 further comprising:
a left side rail extending along the left side of the aperture in the frame, and
a right side rail extending along the right side of the aperture in the frame, wherein a portion of the panel extends into the left side rail and the right side rail.

16. The air flow metering device of claim 12 wherein the left side strap is a left side cable and the right side strap is a right side cable.

17. The air flow metering device of claim 16 wherein the left side strap winding section is a left side tapered cable winding cone connected to the drum for winding and unwinding the left side cable and the right side strap winding section is a right side tapered cable winding cone connected to the drum for winding and unwinding the right side cable.

18. An air flow metering device for controlling the flow of air into a vehicle passage comprising:
an airflow path with a first roller positioned at a first side of the air flow path and a second roller positioned at an opposing side of the air flow path;
a continuous roll of double panel fabric material connected between the first roller and the second roller so that the continuous roll of double panel fabric material extends across the airflow path;
a first fabric covering and a second fabric covering of the continuous roller of double panel fabric material that are rotated by first roller and the second roller to meet at a middle of an air flow path to create a blockage;
a first opening and a second opening of the continuous roller of double panel fabric material that are rotated, wherein the first roller and the second roller rotate the first fabric covering and the second fabric covering to form an opening starting at the middle of the air flow path as the first fabric covering and the second fabric covering withdraw away from each other to are rolled onto a respective one of the first roller and the second roller.

19. The airflow metering device of claim 18 wherein a continuous loop drive system is used for actuating both first and second airflow fabric members simultaneously.

20. The airflow metering device of claim 18 further comprising:
an edge of the first opening and an edge of the second opening;
two end rails each added to a respective one of the edges of each opening;
a seal formed on one of the two end rails for contacting the other one of the two end rails for forming a seal when the first fabric covering and the second fabric covering meet at the middle of the air flow path to create the blockage.
